(19) United States
(12) Patent Application Publication
(10) Pub. No.: US 2016/0272110 A1
(43) Pub. Date: Sep. 22, 2016

(54) Automatically Self Canceling Turn Signal Lamp for Vehicles

(71) Applicant: James Zweighaft, Boulder, CO (US)

(72) Inventor: James Zweighaft, Boulder, CO (US)

(21) Appl. No.: 14/661,329

(22) Filed: Mar. 18, 2015

(51) Int. Cl. B60Q 1/34; H05B 33/08; H05B 37/02

(52) U.S. Cl. CPC B60Q 1/34; H05B 37/0227; H05B 33/0854

(57) ABSTRACT

A motor vehicle turn signal lamp containing a electronic circuit that fits into a standard automotive turn signal lamp socket without modification, with the added feature that it will stop flashing after a set time even if the driver has forgotten to cancel the turn signal. Special circuitry within the bulb housing allows it to operate uninterrupted on the pulsing, intermittent power normally delivered by an external turn signal system. Because the lamp has the same external size and shape as an ordinary turn signal lamp, the desirable self canceling feature can be added to any vehicle simply by changing out the original lamps and replacing them with the object of this invention.

### SUMMARY OF THE INVENTION

An automotive turn signal lamp in a standard form factor containing an electronic circuit that will cancel flashing automatically after a set time. The standard form factor allows for simple retrofitting to existing vehicles.

### FIELD OF THE INVENTION

This invention relates to motor vehicles such as automobiles and motorcycles, and in particular to the turn signal systems incorporated therein.

### Problem

A common problem that occurs when operating a motor vehicle is the failure of the driver to cancel a turn signal after a lane change or other maneuver, leaving the signal in the “on” state. Besides being an annoyance and distraction to other drivers on the road, this situation can also be hazardous to all involved. Although newer vehicles are sometimes equipped with more sophisticated turn signal canceling mechanisms, there remains a very large number of current and older vehicles that will not automatically prevent this situation. In the case of motorcycles, leaving the turn signal on is especially dangerous as it can lead to head on collisions that can be fatal.

For many years, most cars have been designed with a mechanical feature that will shut off the turn signal if the steering wheel is turned by a large amount back toward the center position. This feature only works well at lower speeds when the amount of steering wheel movement is large. At higher speeds, only a small motion of the steering wheel is usually required which is insufficient to trigger this method of canceling the turn signal, thus requiring the driver to cancel the signal manually. Occasionally a driver fails to do this, leaving the turn signal on for an extended period of time. On motorcycles, no such mechanism is typically fitted although the risk from a uncanceled signal is particularly acute.

Some new vehicles are now equipped with sophisticated turn signal canceling systems employing sensors for a variety of inputs such as time, speed, acceleration, distance traveled and even angular rotation. However, it is prohibitively expensive to retrofit an existing vehicle with such a system and there is some risk that said modification will result in other failures. In light of this, few vehicles owners are willing to have this work done and so the problem of turn signals accidentally left flashing for long periods of time will remain for many years to come.

### Solution

This invention provides a simple and inexpensive way to incorporate a more sophisticated turn signal canceling mechanism into an existing vehicle simply by changing the turn signal lamp itself. No modification of the original vehicle wiring is required.

This objective is achieved with a bulb design that appears externally to be the same as a standard existing bulb such as the common model 1156. To do this, it is necessary to design a circuit that can count flashes of the turn signal continuously even though it is only powered when the flash occurs. Typically there is about a half second between flashes when the circuit receives no power. During this brief unpowered time the microprocessor must retain a count of how many flashes have occurred without resetting. This is achieved by storing a small amount of power on a capacitor and minimizing the power draw of the microprocessor during the off cycle, by going into a low power “sleep” mode. The circuit is reset if the power remains off for significantly longer than the normal flash cycle, such as four seconds.

A optional feature of this design is the ability to greatly reduce the electronic load (resistance) once flashing is canceled. In most vehicles, this will result in the dash indicator flashing more rapidly than normal thereby alerting the driver that he or she has failed to manually cancel the turn signal and perhaps prompting more attentive behavior in the future. Note that the dash lamp will flash rapidly even though the turn signal lamp is completely off.

In normal operation, the time lapse from when a turn signal is activated to when it needs to be deactivated varies considerably. The circuit design can be set to cancel after any number of flashes but would typically be preset to a longer interval as the intent is to prevent extended periods of driving with the turn signal on.

While the simplest implementation of the turn signal canceling algorithm involves counting flashes, it is possible to incorporate more sophisticated methods without requiring any external connections other than power and ground. For instance, acceleration, gyroscopic and even GPS (Global Positioning System) chips are available that are small enough to be incorporated inside the lamp itself at some additional cost.

In some situations, it may be necessary to override the self canceling feature of this invention. This can be accomplished without using more sophisticated sensors which add cost. For instance, the self canceling feature can be prevented if the driver turns the signal on, then off for two or three flash cycles and then on again. Leaving the signal off for four or more flash cycles will reset the microprocessor and the algorithm, a situation commonly referred to as a “cold start”.

Past inventions have attempted to solve the problem of easily retrofitting a self canceling turn signal to an existing vehicle by proposing to replace part of the vehicle's electronic system commonly called the “flasher unit”. The circuitry required to do so is considerably simpler than that proposed by this invention because power is supplied to the flasher unit in a continuous fashion regardless of whether or not the lamp is flashing. Therefore there is not necessary to cache power or put the microprocessor in a low power state during the unpowered portion of the flash cycle. However, the flasher unit is less commonly replaced than a turn signal lamp and is typically harder to access and change. Furthermore, the design of flasher units is not as standardized as turn signal lamps, and thus a variety of designs would have to be implemented to cover the available pool of vehicles need such a system.

### BRIEF DESCRIPTIONS OF THE DRAWINGS

FIG. 1 is a block diagram of the circuitry to be housed entirely within the turn signal bulb and operating on intermittently applied power.

FIG. 2 is a flowchart of the software algorithm executed by the microprocessor which is part of the circuitry housed in the turn signal lamp.

### DETAILED DESCRIPTION OF THE DRAWINGS

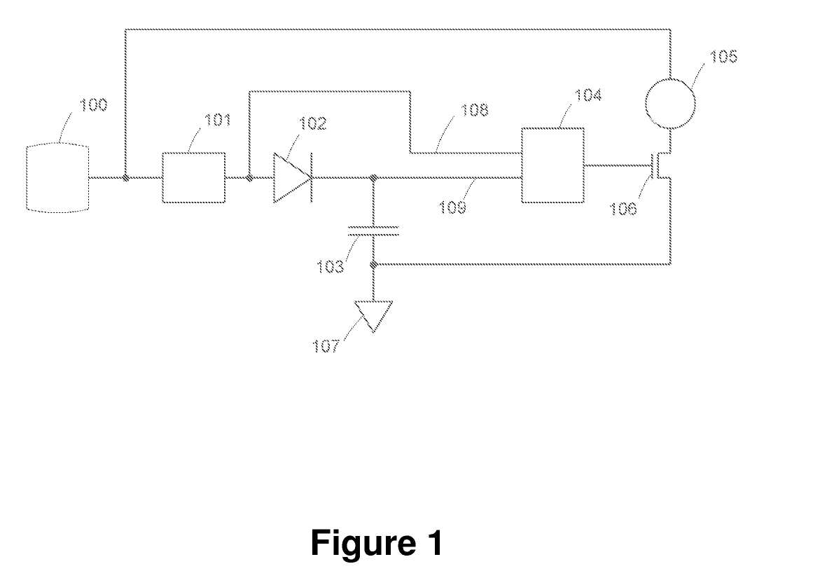

Referring to FIG. 1, an external electrical circuit 100 supplies nominally 12 volt power in a pulsing or flashing manner when the system is activated. The external circuit is not part of this invention but is shown in FIG. 1 as its operation is crucial to the design and operation and design of the system. The rate of pulsing is typically once per second, with a duty cycle of 50% although the exact amount will vary somewhat from vehicle to vehicle. Contained with the invention is voltage regulator 101 which coverts the (nominally) 12 volt power to a lower voltage suitable for microprocessor 104, such as 5 volts. Diode 102 allows current to flow from voltage regulator 101 to capacitor 103 when external power is applied, but prevents capacitor 103 from discharging back through voltage regulator 101 when external power is not applied. Therefore, a small amount of voltage will remain trapped or cached on capacitor 103 which is sufficient to power microprocessor 104 for a short period of time provided it is in a low power state. This feature allows microprocessor 104 to retain a count of how many flashes have occurred.

Microprocessor 104 is designed to use only a small amount of power and is capable of operating within a range voltages, such as 5 to 2 volts which is supplied at power input 109. The exact range of voltages will vary depending on the chip manufacturer. Microprocessor 104 will continue to operate for a short period of time such as two seconds, using power stored on capacitor 103 even in the absence of voltage from external circuit 100. During this time, the voltage on capacitor 103 will decay slowly compared to the pulsing rate of external circuit 100 but remain high enough to avoid resetting microprocessor 104. As long as external circuit 100 reapplies 12 volts to voltage regulator 101 before the voltage on capacitor 103 has decayed below 2 volts, microprocessor 104 will continue to operate uninterrupted. If externalcircuit 100 has been off for more than several seconds, capacitor 103 will discharge below 2 volts and microprocessor 104 will lose power. If external power source 100 then begins to pulse, microprocessor 104 will go through a reset (commonly known as a “cold start” sequence) which consists of initializing the flash count to zero, and turning on power transistor 106 which is in series with high brightness LED 105. Note that power is applied to high brightness LED 105 directly from external circuit 100 and does not drain power from capacitor 103 at any time.

Microprocessor 104 is able to detect and count the pulses of external power source 100 though signal line 108 as long as the voltage on capacitor 103 remains above approximately 2 volts. After counting a predetermined number of pulses, microprocessor 104 disables power transistor 106 which prevents LED 105 from illuminating even though external circuit 100 continues to pulse.

The times and voltages cited in this description are for illustrative purposes and may vary without compromising the invention within limits. The key feature is that capacitor 103 is capable of supplying power to microprocessor 104 during the normal off time of external circuit 100 so that the flash count is retained. Another key feature is that microprocessor 104 will drain enough power from capacitor 103 over a longer period of time to allow the system to reset.

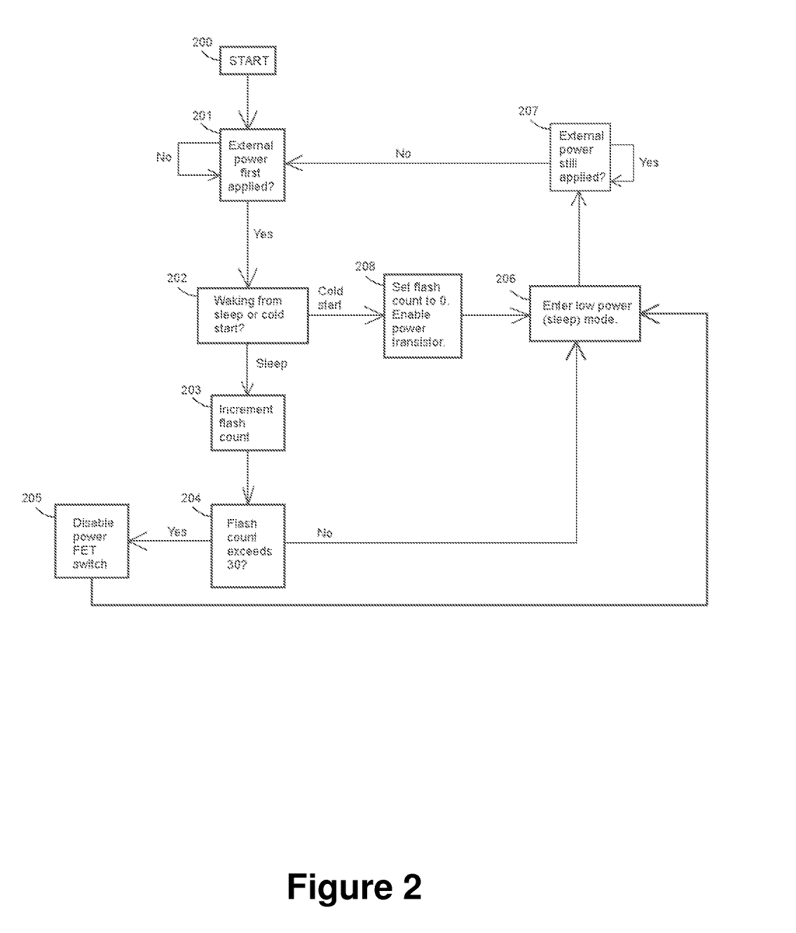

FIG. 2 is a flow diagram showing the operation of software to be executed by microprocessor 104. Step 200 is the starting point shown for clarity but code execution always proceeds to step 201 where a check is made for the application of external power. If, external power is detected, a decision is made in step 202 depending on how long it has been since power was detected, which may occur after a long absence (such as several seconds or longer) in which case capacitor 103 will have been depleted below 2 volts and thus microprocessor 104 will do a cold start in step 208. In this context, a “cold start” means microprocessor 104 will execute its initialization sequence which includes enabling power transistor 106 and setting the flash count (typically a variable in RAM) to zero.

However, if external power has been lost for a shorter period of time such as one half second, microprocessor 104 will wake from a [symbol] leep [symbol] condition in step 202 during which it retains the state of the flash count, which is then incremented in step 203 and compared to a preset limit (such as 30) in step 204. If the flash count exceeds the preset limit, power transistor 106 is disabled in step 205, which prevents high brightness LED 105 from illuminating even when external power is present. If the flash count is not found to exceed the preset limit in step 204, microprocessor 104 will enter a low power (sleep) mode in step 206 and remain there in step 207 until external power is lost and then returns in step 102. Note that microprocessor 104 is capable of maintaining the state of it's outputs during sleep mode, so the operation of power transistor 106 is not changed.

### DESCRIPTION OF THE PREFERRED EMBODIMENT

The invention has been implemented using a commercially available PSoC 4000 microprocessor from Cypress Corporation of San Jose, Calif. Like other modern embedded control ICs, this chip is capable of going into a lower power sleep mode during which time it will retain the values of variables in RAM (such as the flash count), and hold its output pins in their preferred state. There are other commercially available parts with similar capabilities.

Conversion of external 12 volt (nominal) power to a range useable by the PSoC 4000 is accomplished by a dc-dc converter chip model AP1117 from Diodes, Incorporated of Plano Tex. The high brightness LED is enabled using a power field effect transistor (FET) model DMG1012, also from Diodes, Incorporated. Other components used in the preferred embodiment but not shown in FIG. 1 consist of bypass capacitors and current limiting resistors the need for which is well understood by those skilled in the art.

The software implementing the flowchart in FIG. 2 was written in the “C” programming language as is common in the industry.

What is claimed:

1- A vehicle turn signal lamp capable of operating on intermittent, pulsing power that automatically stops illuminating after a set number of applications of external power without requiring any inputs other than power and ground.

2- The apparatus of claim 1, whereby the system is reset by removing power for preset time limit exceeding the normal duty cycle of the intermittent external power source.

3- The apparatus of claim 1, whereby flashing is interrupted based on input from an acceleration sensor.

4- The apparatus of claim 1, whereby flashing is interrupted based on input from an angular position sensor such as a gyroscope.

5- The apparatus of claim 1, whereby flashing is interrupted based on input from a Global Positioning Sensor.
